(19) United States
(12) Patent Application Publication
(10) Pub. No.: US 2012/0086655 A1
(43) Pub. Date: Apr. 12, 2012

(54) TOUCH DISPLAY PANEL

(75) Inventors: Wen-Chun Wang, Taichung City (TW); Chin-Chang Liu, Taichung County (TW); Kuo-Chang Su, Tainan County (TW); Hsi-Rong Han, Taichung County (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/253,063

(22) Filed: Oct. 4, 2011

(30) Foreign Application Priority Data
Oct. 11, 2010 (TW) 99134607

(51) Int. Cl. G06F 3/041

(52) U.S. Cl. 345/173; 345/77

(57) ABSTRACT

A touch display panel including a first substrate, a second substrate, a touch sensing structure, a decoration film, an organic light emitting diode pixel array, and a sealant is provided. The touch sensing structure is disposed on the first substrate. The second substrate is opposite to a surface of the first substrate disposed with the touch sensing structure. The decoration film is disposed on the first substrate. The organic light emitting diode pixel array is located between the touch sensing structure and the second substrate. The sealant is disposed between the first substrate and the second substrate and seals the organic light emitting diode pixel array between the first substrate and the second substrate.

### CROSS-REFERENCE TO RELATED APPLICATION

This application claims the priority benefit of Taiwan application serial no. 99134607, filed Oct. 11, 2010. The entirety of the above-mentioned patent application is hereby incorporated by reference herein and made a part of this specification.

### BACKGROUND OF THE INVENTION

1. Field of the Invention

The invention generally relates to a touch display panel, and more particularly, to a touch display panel employing an organic light emitting layer for display.

2. Description of Related Art

The current designs of conventional touch display panels are generally categorized, based on their touch sensing principles, into resistive, capacitive, optical, sound wave, and electromagnetic touch display panels, in which the resistive and capacitive touch display panels are the mainstream.

Currently, the touch display panel is usually manufactured by separately fabricating the touch panel and the display panel, then assembling the touch panel and the display panel. However, touch display panels manufactured in this manner have a higher cost, a heavier weight, and a lower light transmittance rate, and thus these touch display panels can be further improved.

### SUMMARY OF THE INVENTION

Accordingly, the invention is directed to a touch display panel, in which a touch sensing structure is disposed between two substrates sealing an organic light emitting diode (OLED) pixel array, so as to achieve an image display and a touch sensing function at the same time without adding to panel thickness.

The invention is directed to a touch display panel, including a first substrate, a second substrate, a touch sensing structure, a decoration film, an OLED pixel array, and a sealant. The decoration film is disposed on the first substrate. The touch sensing structure is disposed on the first substrate and located between the first substrate and the second substrate. The second substrate is opposite to a surface of the first substrate disposed with the touch sensing structure. The OLED pixel array is located between the touch sensing structure and the second substrate. The sealant is disposed between the first substrate and the second substrate, and the sealant seals the OLED pixel array between the first substrate and the second substrate.

In summary, an embodiment of the invention disposes the touch sensing structure on the substrate sealing the OLED pixel array, so as to form a touch display panel. Moreover, the decoration film is disposed on the aforementioned substrate according to an embodiment of the invention, so the touch display panel does not need an additional cover glass. Accordingly, besides the two substrates sealing the OLED pixel array, no other substrates is required, thereby reducing the thickness of the touch display panel.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a touch display panel according to a first embodiment of the invention.

FIG. 1B is a top schematic view of a first substrate and a second substrate in the touch display panel depicted in FIG. 1A.

FIG. 2 is a schematic cross-sectional view of a touch display panel according to a second embodiment of the invention.

FIG. 3 is a schematic cross-sectional view of a touch display panel according to a third embodiment of the invention.

FIG. 4 is a schematic cross-sectional view of a touch display panel according to a fourth embodiment of the invention.

FIG. 5 is a schematic cross-sectional view of a touch display panel according to a fifth embodiment of the invention.

FIG. 6 is a schematic cross-sectional view of a touch display panel according to a sixth embodiment of the invention.

FIG. 7 is a schematic cross-sectional view of a touch display panel according to a seventh embodiment of the invention.

FIG. 8 is a schematic cross-sectional view of a touch display panel according to an eighth embodiment of the invention.

### DESCRIPTION OF EMBODIMENTS

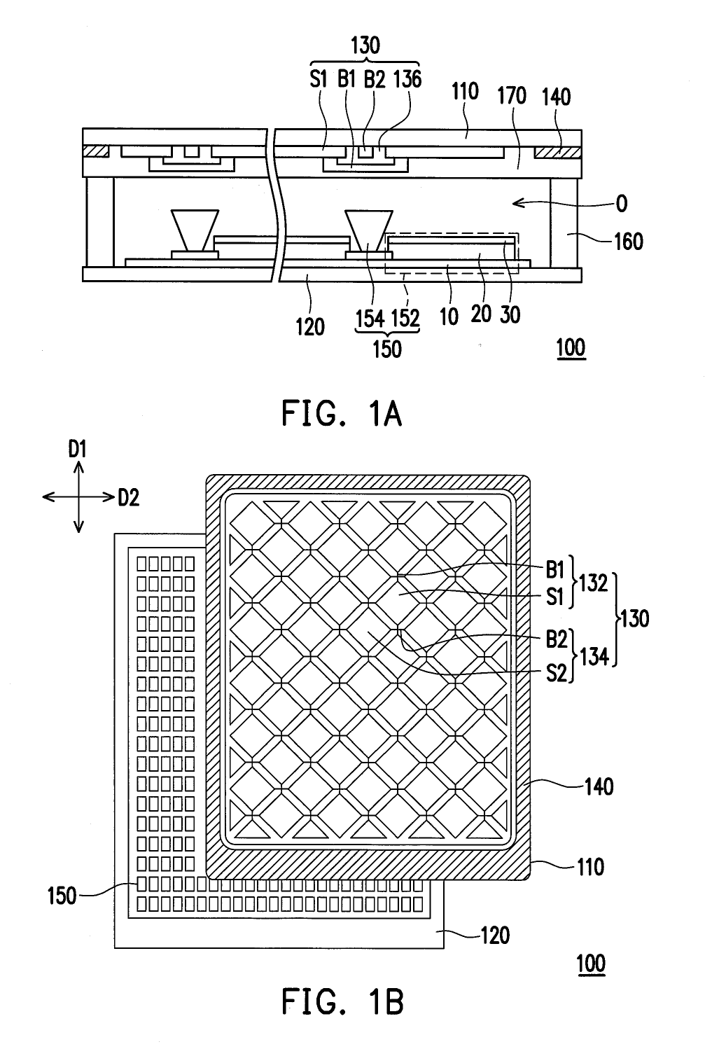

FIG. 1A is a schematic cross-sectional view of a touch display panel according to a first embodiment of the invention, while FIG. 1B is a top schematic view of a first substrate and a second substrate in the touch display panel depicted in FIG. 1A. Referring to FIGS. 1A and 1B, a touch display panel 100 includes a first substrate 110, a second substrate 120, a touch sensing structure 130, a decoration film 140, an organic light emitting diode (OLED) pixel array 150, and a sealant 160. The first substrate 110 is opposite to the second substrate 120. The touch sensing structure 130 is disposed on the first substrate 110 and located between the first substrate 110 and the second substrate 120. The decoration film 140 is disposed on the first substrate 110. The OLED pixel array 150 is disposed on the second substrate 110. The sealant 160 is disposed between the first substrate 110 and the second substrate 120, and the sealant 160 seals the OLED pixel array 150 between the first substrate 110 and the second substrate 120. Moreover, in the present embodiment, the touch display panel 100 may further include a protection layer 170 disposed on a side of the touch sensing structure 130 away from the first substrate 110, and the protection layer 170 may be configured to protect the touch sensing structure 130. More specifically, a space O enclosed by the first substrate 110, the second substrate 120, and the sealant 160 may be selectively filled with a cured optical glue material, so as to enhance a mechanical strength of the touch display panel 100 and to provide a preferred light transmittance rate.

In the present embodiment of the invention, the decoration film 140 is disposed in an area substantially surrounding a periphery of the first substrate 110. The first substrate 110 may be a plastic substrate, a glass substrate, or any other appropriate transparent substrates. The decoration film 140 forms a ring-like light-shielding pattern (e.g., as depicted in FIG. 1B) which may be used to shield the traces or the circuit layout around the touch display panel 100, so as to enhance the appearance of the touch display panel 100. However, in other embodiments, the decoration film 140 may also be locally disposed at the periphery of the first substrate 110, so as to form a specialized mark pattern. The touch sensing structure 130 disposed on the first substrate 110 may provide a touch sensing function. The touch sensing structure 130 and the decoration film 140 of the embodiment are both disposed on the first substrate 110 used for covering the OLED pixel array 150. Therefore, the touch display panel 100 may have a preferably thin-volume design since it does not require the addition of other substrates. In other words, the present embodiment of the invention employs only two substrates (110 and 120) to seal the OLED pixel array 150, while at the same time, the touch display panel 100 has image display and touch sensing functions along with an elegant appearance.

More specifically, the OLED pixel array 150 includes a plurality of OLED pixel units 152 and an isolation structure 154. The isolation structure 154 is configured to isolate the OLED pixel units 152 from each other. In other words, the isolation structure 154 may be used as a boundary to divide the OLED pixel units 152. The isolation structure 154 may have a single layer lattice structure, or the isolation structure 154 may be formed by stacking a plurality of lattice structures. The invention does not specifically limit how the isolation structure 154 is formed.

Moreover, each of the OLED pixel units 152 includes a first electrode 10, an organic light emitting layer 20, and a second electrode 30 stacked in sequence. It should be noted that, the afore-described sequential disposition is not limited to a sequential disposition of the first substrate 110 facing the second substrate 120, or a sequential disposition of the second substrate 120 facing the first substrate 110. Accordingly, the disposition sequence depicted in FIG. 1A is merely used as an illustrative example, and not for limiting the first electrode 10 to being near the second substrate 120. Further, in this embodiment, the OLED pixel array 150 is disposed on the second substrate 120 and opposite to the touch sensing structure 130.

More specifically, the first electrode 10 and the second electrode 30 may be respectively a cathode and an anode, or an anode and a cathode. Moreover, only the second electrode 30 among the first and second electrodes 10 and 30 is a transparent electrode, such that a light emitted from the organic light emitting layer 20 emerges towards the first substrate 110. In addition, both the first and second electrodes 10 and 30 may be transparent electrodes, such that the light emitted from the organic light emitting layer 20 emerges simultaneously towards the first substrate 110 and the second substrate 120. In other words, the touch display panel 100 according to the present embodiment may have a single-sided display design or a double-sided display design.

Furthermore, the touch sensing structure 130 includes a plurality of first sensing lines 132 and a plurality of second sensing lines 134. The first sensing lines 132 are, for example, electrically insulated from the second sensing lines 134, and a first extended direction D1 of each of the first sensing lines 132 is different from a second extended direction D2 of each of the second sensing lines 134. Each of the first sensing lines 132 includes a plurality of first sensing pads S1 and a plurality of first bridge lines B1 serially connecting the first sensing pads S1 along the first extended direction D1. Each of the second sensing lines 134 includes a plurality of second sensing pads S2 and a plurality of second bridge lines B2 serially connecting the second sensing pads S2 along the second extended direction D2. Moreover, in order to facilitate the electrical property of each element, the touch sensing structure 130 further includes an insulator pattern 136 disposed between the first bridges lines B1 and the second bridge lines B2. As shown in FIG. 1A, the first bridge lines B1 cross over the insulator pattern 136 to serially connect the neighboring first sensing pads S1, for example.

In the present embodiment, by using only two substrates (110 and 120), the components used for display, touching sensing, and decoration are integrated together. Therefore, without significantly adding to the thickness, the touch display panel 100 can achieve the touch sensing and display functions while enhancing the appearance.

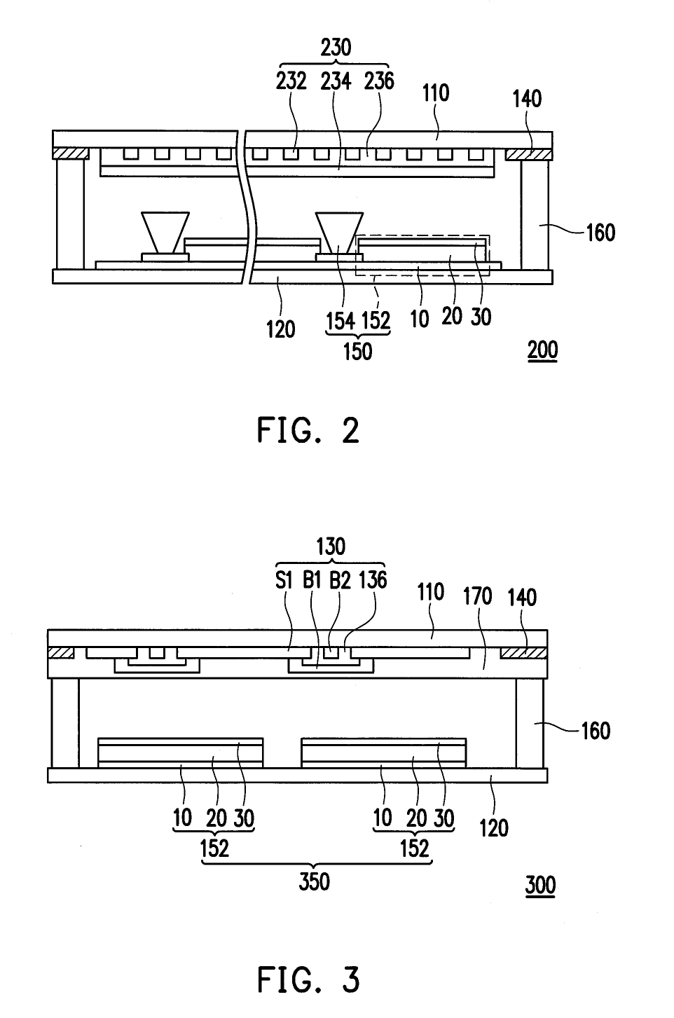

However, it should be noted that, the touching sensing structure 130 may be implemented in other manners. For example, FIG. 2 is a schematic cross-sectional view of a touch display panel according to a second embodiment of the invention. Referring to FIG. 2, a touch display panel 200 is similar to the touch display panel 100, and in these two embodiments of the invention, the same components are denoted with the same reference symbols. A difference between the present embodiment and the first embodiment is that, a touch sensing structure 230 of the touch display panel 200 is formed by a plurality of first strip electrodes 232 and a plurality of second strip electrodes 234. Moreover, an insulator layer 236 is disposed between the first strip electrodes 232 and the second strip electrodes 234. In other words, the present embodiment employs strip electrodes as the touch sensing devices. Moreover, in other implementations, the first strip electrodes 232 and the second strip electrodes 234 may be respectively disposed at two opposite sides of the first substrate 110, and here the insulator layer 236 disposed between the first strip electrodes 232 and the second strip electrodes 234 may not be required in the touch sensing structure 230.

FIG. 3 is a schematic cross-sectional view of a touch display panel according to a third embodiment of the invention. Referring to FIG. 3, a touch display panel 300 includes a first substrate 110, a second substrate 120, a touch sensing structure 130, a decoration film 140, an OLED pixel array 350, a sealant 160, and a protection layer 170. Similar to the first embodiment, the first substrate 110 is opposite to the second substrate 120. The touch sensing structure 130 is disposed on the first substrate 110, and the OLED pixel array 350 is disposed on the second substrate 120. The decoration film 140 is disposed on the first substrate 110 and substantially surrounds a periphery of the first substrate 110. The sealant 160 is disposed between the first substrate 110 and the second substrate 120, and the sealant 160 seals the OLED pixel array 350 between the first substrate 110 and the second substrate 120. Moreover, the protection layer 170 is disposed on a side of the touch sensing structure 130 away from the first substrate 110, so as to protect the touch sensing structure 130.

In the embodiment, the OLED pixel array 350 includes, for example, a plurality of OLED pixel units 152 separated from each other. Moreover, some of the OLED pixel units 152 do not require the isolation structure 154 depicted in FIG. 1A for separation. In other words, a difference between the present embodiment and the first embodiment is the omission of the isolation structure in the touch display panel 300. More specifically, during a manufacturing process of the touch display panel 300, a patterning technique may be employed to form a plurality of OLED pixel units 152 which are separated from each other, thereby saving the step of fabricating the isolation structure.

The description of the touch sensing structure 130 can be referenced to the corresponding description in the first embodiment. That is to say, the top view of the touch sensing structure 130 in the touch display panel 300 can be referenced to the illustration in FIG. 1B, which includes the first sensing lines 132 and the second sensing lines 134. In the present embodiment, by disposing the touch sensing structure 130 and the OLED pixel array 350 between the first substrate 110 and the second substrate 120, the functions of display and touch sensing may be integrated into a same panel without adding the dimension of the touch display panel 300. Moreover, the decoration film 140 may cover the traces or circuitry disposed on the periphery, so that the touch display panel 300 has an elegant appearance. Naturally, the present embodiment of the invention does not limit the light emergent direction of the OLED pixel array 350. At least one of the first and second electrodes 10 and 30 may be a transparent electrode from which a display light may pass through. Therefore, the touch display panel 300 may be a double-sided display panel or a single-sided display panel.

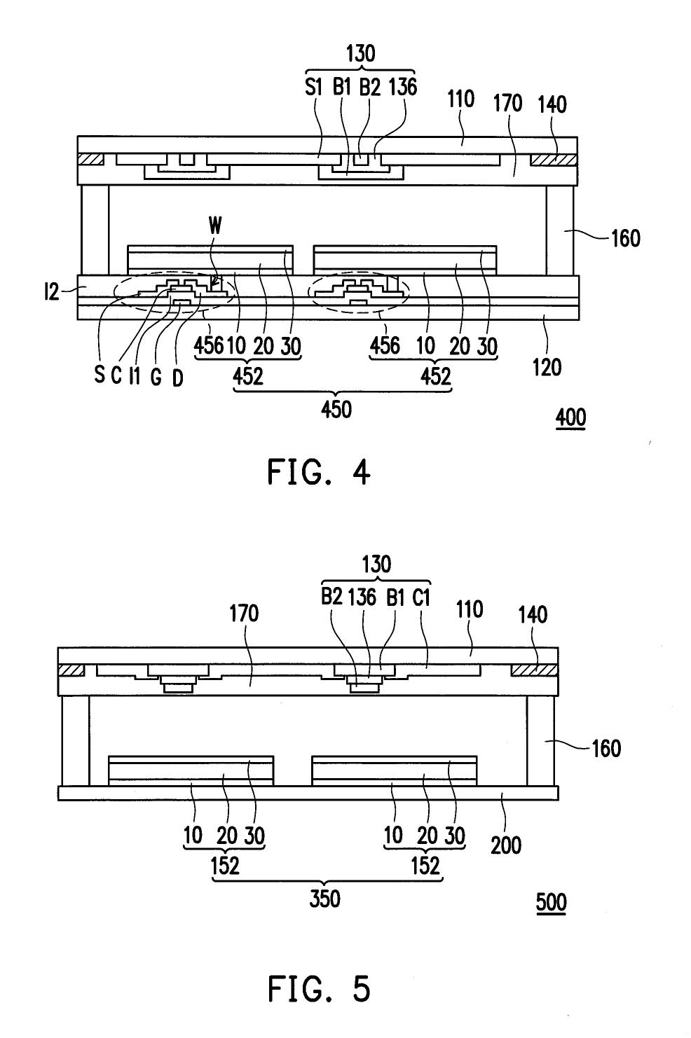

FIG. 4 is a schematic cross-sectional view of a touch display panel according to a fourth embodiment of the invention. Referring to FIG. 4, a touch display panel 400 is substantially similar to the afore-described touch display panel 300, and in the touch display panels 400 and 300, the same components are denoted with the same reference symbols and omitted from further description. Specifically, a difference between the two touch display panels 300 and 400 is that, in the present embodiment, each of the OLED pixel units 452 in an OLED pixel array 450 includes a first electrode 10, an organic light emitting layer 20, a second electrode 30, and an active device 456.

The active device 456 is electrically connected to the first electrode 10, such that the OLED pixel array 450 can be actively driven. The active device 456 includes, for example, a gate G, an insulator layer I1, a channel layer C, a source S, a drain D, and an insulator layer I2. By control through the active device 456, each of the OLED pixel units 452 can display a corresponding brightness so as to form a required display image. In other words, the invention does not limit the driving method of the OLED pixel units 452 into an active design or a passive design.

FIG. 5 is a schematic cross-sectional view of a touch display panel according to a fifth embodiment of the invention. Referring to FIG. 5, a touch display panel 500 is substantially similar to the touch display panel 300. A difference between the two touch display panels is in the cross-sectional design of a touch sensing structure 530. In the present embodiment, the first bridge lines B1, the insulator pattern 136, and the second bridge lines B2 are, for example, disposed in sequence on the first substrate 110. In other words, the first bridge lines B1 are located between the first substrate 110 and the insulator pattern 136, and the second bridge lines B2 are located between the insulator pattern 136 and the protection layer 170.

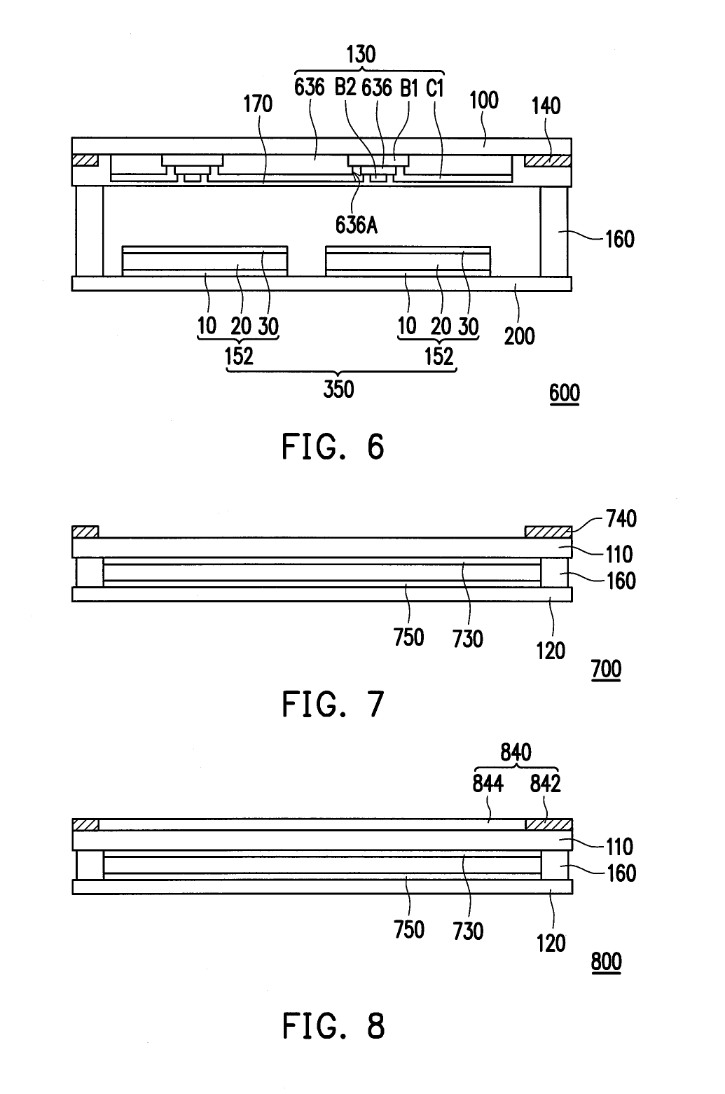

FIG. 6 is a schematic cross-sectional view of a touch display panel according to a sixth embodiment of the invention. Referring to FIG. 6, a touch display panel 600 is similar to the afore-described touch display panel 500. A difference between the two touch panels is that, the touch sensing structure 130 in the touch display panel 600 employs an insulator layer 636 to replace the insulator pattern 136 in the touch display panel 500. In the present embodiment, the insulator layer 636 covers the first substrate 110 and a portion of the first bridge lines B1, and the insulator layer 636 has a plurality of contact windows 636A. Each of the first sensing pads S1 is electrically connected to the first bridge lines B1 through the corresponding contact window 636A. It should be noted that, in the present embodiment and the previously described embodiments, a material of the first bridge lines B1 and the second bridge lines B2 may be selected from transparent conductive materials or may be a metal, and the material of the first and second bridge lines B1 and B2 may be the same or different from a material of the sensing pads S1 and S2. The description detailed in these embodiments merely discloses a portion of the possible implementations of the touch sensing structure 130, and accordingly the invention does not specifically limit the cross-sectional design of the touch sensing structure 130. For example, the touch sensing structure 230 depicted in FIG. 2 may be adopted as a design for the touch display panel of an embodiment of the invention. Moreover, as described earlier, the invention does not limit the display mode of the touch display panels 100-600, and according to a material selection of the electrodes, the touch display panels 100-600 may have a double-sided display design or a single-sided display design.

Furthermore, the decoration film 140 is not confined to the implementations described in the earlier embodiments. In the afore-described embodiments, the decoration film 140 is shown on a side of the first substrate 110 facing the second substrate 120, although the invention is not limited thereto. Moreover, a material of the decoration film 140 may be diamond-like carbon, ceramic, photoresist, ink, or other appropriate materials. FIG. 7 is a schematic cross-sectional view of a touch display panel according to a seventh embodiment of the invention. Referring to FIG. 7, a touch display panel 700 includes a first substrate 110, a second substrate 120, a touch sensing structure 730, a decoration film 740, an OLED pixel array 750, and a sealant 160. The first substrate 110 is opposite to the second substrate 120. The touch sensing structure 730 is disposed on the first substrate 110, and the OLED pixel array 750 is disposed on the second substrate 120. The sealant 160 is disposed between the first substrate 110 and the second substrate 120, so as to seal the OLED pixel array 750 between the first substrate 110 and the second substrate 120. Moreover, the decoration film 740 is, for example, disposed on a side of the first substrate 110 away from the second substrate 120.

In the present embodiment, the touch sensing structure 730 may be selected from one of the touch sensing structures 130 and 230 described previously, and the cross-sectional design of the touch sensing structure 730 may be referenced to one of the implementations illustrated in FIGS. 3, 5, and 6. The OLED pixel array 750 may be selected from one of the afore-described OLED pixel arrays 150, 350, and 450, and the OLED pixel array 750 may be an active or passive pixel array which has an isolation structure or does not have the isolation structure. Moreover, a material of the decoration film 740 may be diamond-like carbon, ceramic, photoresist, ink, or other appropriate materials. A thickness of the decoration film 740 may be sufficiently thin such that a user does not feel unevenness when touching the touch display panel 700. In addition, the decoration film 740 has, for example, an opaque property for covering the traces or the circuit design disposed on the periphery of the touch display panel 700.

FIG. 8 is a schematic cross-sectional view of a touch display panel according to an eighth embodiment of the invention. Referring to FIG. 8, a touch display panel 800 is similar to the afore-described touch display panel 700. A difference between the two touch panels 700 and 800 is that, a decoration film 840 in the touch display panel 800 includes a first portion 842 and a second portion 844. A material of the first portion 842 is, for example, an opaque material, and the first portion 842 is disposed on the periphery of the first substrate 110. A material of the second portion 844 is, for example, a transparent material, and the second portion 844 is disposed in the region enclosed by the first portion 842. In other words, the transparent second portion 844 is, for example, disposed in a display region of the touch display panel 800, whereas the opaque first portion 842 is disposed in a non-display region of the touch display panel 800. It should be noted that, a thickness of the first portion 842 and the second portion 844 may be the same. Consequently, a user does not feel unevenness when touching the touch display panel 800.

In view of the foregoing, an embodiment of the invention disposes the touch sensing structure on the substrate sealing the OLED pixel array. Therefore, the touch display panel may employ the OLED pixel array for display and employ the touch sensing structure for touch detection. The touch display panel does not require an additional substrate to achieve the touch sensing and image display functions at the same time. By adopting a design according to an embodiment of the invention, the touch display panel can have a thinned volume and an enhanced practicality. Moreover, the decoration film in the touch display panel may provide a decorative function for the non-display regions, and accordingly the touch display panel has an elegant appearance.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display panel, comprising:
a first substrate;
a decoration film disposed on the first substrate;
a touch sensing structure disposed on the first substrate;
a second substrate is opposite to a surface of the first substrate disposed with the touch sensing structure;
an organic light emitting diode (OLED) pixel array disposed on the second substrate and located between the touch sensing structure and the second substrate; and
a sealant disposed between the first substrate and the second substrate, the sealant sealing the OLED pixel array between the first substrate and the second substrate.

2. The touch display panel as claimed in claim 1, wherein the OLED pixel array comprises a plurality of OLED pixel units, each of the OLED pixel units comprising a first electrode, an organic light emitting layer, and a second electrode stacked in sequence.

3. The touch display panel as claimed in claim 2, wherein the OLED pixel array further comprises an isolation structure isolating at least the neighboring OLED pixel units from each other.

4. The touch display panel as claimed in claim 2, wherein the OLED pixel array further comprises a plurality of active devices, each of the active devices electrically connected to one of the OLED pixel units.

5. The touch display panel as claimed in claim 1, wherein the touch sensing structure comprises:
a plurality of first sensing lines; and
a plurality of second sensing lines electrically insulated from the first sensing lines, and a first extended direction of each of the first sensing lines is different from a second extended direction of each of the second sensing lines.

6. The touch display panel as claimed in claim 5, further comprising a protection layer disposed on a side of the touch sensing structure away from the first substrate.

7. The touch display panel as claimed in claim 5, wherein each of the first sensing lines comprises a plurality of first sensing pads and a plurality of first bridge lines serially connecting the first sensing pads along the first extended direction, and each of the second sensing lines comprises a plurality of second sensing pads and a plurality of second bridge lines serially connecting the second sensing pads along the second extended direction.

8. The touch display panel as claimed in claim 5, wherein each of the first sensing lines is formed by a first strip electrode, and each of the second sensing lines is formed by a second strip electrode.

9. The touch display panel as claimed in claim 1, wherein the decoration film is disposed on a side of the first substrate away from the second substrate.

10. The touch display panel as claimed in claim 1, wherein the decoration film is located between the first substrate and the second substrate.

11. The touch display panel as claimed in claim 1, wherein a material of the decoration film comprises diamond-like carbon, ceramic, photoresist, or ink.

12. The touch display panel as claimed in claim 1, wherein a space enclosed by the first substrate, the second substrate, and the sealant is filled with a cured optical glue material.
